(19) United States
(12) Patent Application Publication
(10) Pub. No.: US 2025/0291977 A1
(43) Pub. Date: Sep. 18, 2025

(54) METHOD AND SYSTEM FOR AUTONOMOUS DRIVING OBJECT SIMULATION BASED ON SCENARIO

(71) Applicant: MORAI INC., Seoul (KR)

(72) Inventors: Eungbaek KIM, Seoul (KR); Sungyeon PARK, Seoul (KR); Seungho JANG, Seoul (KR); Hoseop LEE, Seoul (KR); Hyeihn JO, Seoul (KR); Byeongheon KWON, Seoul (KR)

(21) Appl. No.: 19/225,497

(22) Filed: Jun. 2, 2025

Related U.S. Application Data
(63) Continuation of application No. PCT/KR2023/017204, filed on Nov. 1, 2023.

(30) Foreign Application Priority Data
Dec. 2, 2022 (KR) 10-2022-0166817

(51) Int. Cl. G06F 30/20

(52) U.S. Cl. CPC G06F 30/20

(57) ABSTRACT

A simulation method for an autonomous driving vehicle includes receiving a scenario file, extracting target vehicle data and surrounding vehicle data from the received scenario file, inputting the target vehicle data and the surrounding vehicle data into a simulator so that a target vehicle to be tested and surrounding vehicles are driven by the simulator, creating a first thread for receiving state information of at least one of the target vehicle and the surrounding vehicles from the simulator, and creating a second thread for controlling a state of at least one of the target vehicle and the surrounding vehicles.

### CROSS-REFERENCE TO RELATED APPLICATIONS

This application is a continuation of International Application No. PCT/KR2023/017204 filed on Nov. 1, 2023, which claims priority to Korean Patent Application No. 10-2022-0166817 filed on Dec. 2, 2022, the entire contents of which are herein incorporated by reference.

### FIELD

The present disclosure relates to a scenario-based autonomous driving mobile object simulation method and, more particularly, to a method and a system for simulating an autonomous driving mobile object on the basis of an OpenSCENARIO file.

### BACKGROUND

“Autonomous driving” refers to technology that enables a vehicle or the like to drive autonomously with minimal or no human intervention by recognizing the surrounding environment through devices such as LIDAR (light detection and ranging), GNSS (Global Navigation Satellite System), and cameras. Because the actual driving environment includes numerous elements that affect autonomous driving, such as vehicles and traffic structures within the road area and buildings located outside the road area, an enormous amount of testing is required to secure an autonomously drivable function without human intervention.

To conduct such a large amount of testing, simulators have been developed for verifying algorithms of autonomous driving vehicles in a virtual road environment, and various scenario-based tests are being carried out through the simulators. The Association for Standardization of Automation and Measuring system (ASAM), an automotive standards association, provides the OpenSCENARIO file format for autonomous driving simulation. An OpenSCENARIO file includes data related to pedestrians, mobile objects, and the like.

However, a simulator for autonomous-driving testing may already be built, and in this case the design of the simulator may need to be changed in order to apply an OpenSCENARIO file to the simulator. In that case, design modifications of the simulator incur costs and also delay the time until the OpenSCENARIO file can be applied.

### SUMMARY

The present disclosure provides a scenario-based autonomous-driving mobile-object simulation method, a non-transitory computer-readable recording medium storing instructions, and an apparatus system for solving the above-described problems.

The present disclosure can be implemented in various forms including a method, an apparatus system, and/or a computer-readable non-transitory recording medium storing instructions.

In some implementations, a simulation method for an autonomous driving vehicle performed by at least one processor, may include receiving, by a scenario execution module, a scenario file for autonomous driving simulation, extracting, by the scenario execution module, target vehicle data and surrounding vehicle data used for the autonomous driving simulation from the received scenario file, inputting, by the scenario execution module, the target vehicle data and the surrounding vehicle data into a simulator so that a target vehicle to be tested and surrounding vehicles are driven by the simulator, creating, by the scenario execution module, a first thread for receiving state information of at least one of the target vehicle and the surrounding vehicles from the simulator, and creating, by the scenario execution module, a second thread for controlling a state of at least one of the target vehicle and the surrounding vehicles, wherein autonomous driving of the target vehicle is simulated by the simulator using an autonomous driving algorithm.

In some implementations, the simulation method for an autonomous driving vehicle further includes before inputting the target vehicle data and the surrounding vehicle data into the simulator, extracting, by the scenario execution module, reference data associated with map data used for the autonomous driving simulation from the scenario file, and inputting, by the scenario execution module, the extracted reference data into the simulator so that a virtual road associated with the map data is loaded by the simulator.

In some implementations, the simulation method for an autonomous driving vehicle further includes extracting, by the scenario execution module, at least one of pedestrian data and obstacle data used for the autonomous driving simulation from the scenario file, and inputting, by the scenario execution module, the extracted at least one of pedestrian data and obstacle data into the simulator so that at least one of a pedestrian associated with the pedestrian data and an obstacle associated with the obstacle data is loaded by the simulator.

In some implementations, the simulation method for an autonomous driving vehicle further includes before inputting the target vehicle data and the surrounding vehicle data into the simulator, establishing, by the scenario execution module, a communication connection with the simulator in response to receiving a user input for initiating the simulation.

In some implementations, extracting the target vehicle data and the surrounding vehicle data from the received scenario file may include parsing, by the scenario execution module, respective data included in the scenario file based on a data format input to the simulator, and extracting, by the scenario execution module, the target vehicle data and the surrounding vehicle data from the parsed data.

In some implementations, the simulation method for an autonomous driving vehicle further includes after creating the first thread, receiving, by the scenario execution module through the first thread, state information about the target vehicle from the simulator at predetermined periodic intervals.

In some implementations, the simulation method for an autonomous driving vehicle further includes after creating the second thread, inputting, by the scenario execution module through the second thread, first control data for controlling the target vehicle into the simulator, and receiving, by the scenario execution module through the first thread, state information of the target vehicle controlled based on the first control data from the simulator.

In some implementations, the simulation method for an autonomous driving vehicle further includes after creating the second thread, extracting, by the scenario execution module, second control data for controlling the target vehicle and third control data for controlling the surrounding vehicles from sudden situation data, inputting, by the scenario execution module through the second thread, the second control data and the third control data into the simulator, and receiving, by the scenario execution module through the first thread, state information of the target vehicle controlled based on the second control data and state information of the surrounding vehicles controlled based on the third control data from the simulator.

In some implementations, the simulation method for an autonomous driving vehicle further includes after receiving the state information of the surrounding vehicles from the simulator, determining, by the scenario execution module, whether an accident involving the target vehicle occurred based on the state information of the target vehicle and the state information the surrounding vehicles, and storing, by the scenario execution module, a result of the determined accident occurrence, the state information of the target vehicle, and the state information of the surrounding vehicles in association with each other.

In some implementations, a computer-readable non-transitory recording medium storing instructions executable by a computer for performing the above methods.

In some implementations, an apparatus may include a memory, and at least one processor connected to the memory and configured to execute at least one computer-readable program stored in the memory. The at least one program may include instructions to receive a scenario file for autonomous driving simulation, extract target vehicle data and surrounding vehicle data used for the autonomous driving simulation from the received scenario file, input the target vehicle data and the surrounding vehicle data into a simulator so that a target vehicle to be tested and surrounding vehicles are driven by the simulator, create a first thread for receiving state information of at least one of the target vehicle and the surrounding vehicles from the simulator, and create a second thread for controlling a state of at least one of the target vehicle and the surrounding vehicles, wherein autonomous driving of the target vehicle is simulated by the simulator using an autonomous driving algorithm.

### BRIEF DESCRIPTION OF THE DRAWINGS

Embodiments of the present disclosure will be described with reference to the accompanying drawings described below, and like reference numerals refer to like elements, but the present disclosure is not limited thereto.

FIG. 1 illustrates a virtual environment in which an autonomous-driving simulation is performed according to an example of the present disclosure.

FIG. 2 is a schematic diagram showing a configuration in which an information-processing system is communicatively connected with multiple user terminals according to an example of the present disclosure.

FIG. 3 is a block diagram showing an internal configuration of a user terminal and an information-processing system according to an example of the present disclosure.

FIG. 4 is a flowchart for explaining a method in which a virtual environment for autonomous-driving simulation is generated through a simulator according to an example of the present disclosure.

FIG. 5 is a flowchart for explaining a method in which state information of a mobile object is acquired through a first thread according to an example of the present disclosure.

FIG. 6 is a flowchart for explaining a method in which a mobile object is controlled through a second thread according to an example of the present disclosure.

FIG. 7 is a flowchart for explaining a method in which a mobile object is controlled on the basis of sudden-situation data according to an example of the present disclosure.

FIG. 8 illustrates state information of a mobile object generated on the basis of a sudden situation.

FIG. 9 is a flowchart for explaining a method in which an autonomous-driving simulation is terminated according to an example of the present disclosure.

FIG. 10 is a flowchart illustrating a simulation method for an autonomous-driving mobile object according to an example of the present disclosure.

### DETAILED DESCRIPTION

Hereinafter, specific details for carrying out the present disclosure will be described in detail with reference to the accompanying drawings. However, detailed descriptions of well-known functions or configurations that may unnecessarily obscure the gist of the present disclosure will be omitted.

In the accompanying drawings, identical or corresponding components are denoted by identical reference numerals. In the following description of the embodiments, repetitive descriptions of identical or corresponding components may be omitted. Nevertheless, omission of a description for a component does not mean that the component is not included in a given embodiment.

Advantages, features, and methods of achieving the advantages of the disclosed embodiments will become apparent from the embodiments described below with reference to the drawings. The present disclosure is not limited to the embodiments set forth below and may be embodied in various forms. The embodiments are provided only to make the present disclosure complete and to fully convey the scope of the present disclosure to those of ordinary skill in the art.

Terms used in the present specification will be briefly explained, and the disclosed embodiments will then be described in detail. The terminology used herein was selected by considering currently widely-used general terms while taking into account the functions disclosed herein. However, this may vary according to the intentions of those skilled in the art, case law, or emergence of new technology. Additionally, in certain cases, terms arbitrarily chosen by the applicant are used, and their meanings will be described in detail in the relevant part of the present disclosure. Therefore, terms used herein should be interpreted based on the meanings of those terms and the overall content of the present disclosure, rather than on mere names of the terms.

A singular expression in this specification generally includes a plural expression unless the context clearly dictates otherwise. Likewise, a plural expression generally includes a singular expression unless the context clearly dictates otherwise. When a portion of the specification states that a certain component “includes” another component, this means that the certain component may further include additional components unless specifically stated otherwise.

The terms “module” or “unit” as used in the specification refer to software or hardware components that perform specific roles; however, they are not limited to software or hardware. A “module” or “unit” may reside in an addressable storage medium and may be configured to be executed by one or more processors. Accordingly, a “module” or “unit” may include at least one of software components, object-oriented software components, class components, task components, processes, functions, attributes, procedures, sub-routines, segments of program code, drivers, firmware, microcode, circuits, data, databases, data structures, tables, arrays, or variables. The functions provided by such components, modules, or units may be combined into a smaller number of components, modules, or units or may be further separated into additional components, modules, or units.

According to one or more aspects of the present disclosure, a “module” or “unit” may be implemented by a processor and a memory. The term “processor” should be interpreted broadly to include a general-purpose processor, a central processing unit (CPU), a microprocessor, a digital signal processor (DSP), a controller, a microcontroller, or a state machine. In some environments, the processor may denote an application-specific integrated circuit (ASIC), a programmable logic device (PLD), a field-programmable gate array (FPGA), or the like. For example, a ‘processor’ may refer to combinations of processing devices, such as a combination of a DSP and a microprocessor, a combination of multiple microprocessors, a combination of one or more microprocessors combined with a DSP core, or any other such configurations. A “memory” should also be interpreted broadly to include any electronic component capable of storing electronic information, such as random-access memory RAM, read-only memory ROM, non-volatile RAM NVRAM, programmable ROM PROM, erasable-programmable ROM EPROM, electrically erasable PROM EEPROM, flash memory, magnetic or optical storage, or registers. If the processor can read from the memory and/or write to the memory, the memory is referred to as being in electronic communication with the processor. The memory integrated in the processor is in electronic communication with the processor.

In the present disclosure, a ‘system’ may include at least one of a server device or a cloud device, but is not limited thereto. For example, the system may be composed of one or more server devices, one or more cloud devices, or a combination where server and cloud devices operate together.

Terms such as “first,” “second,” “A,” “B,” “(a),” and “(b)” used in the following description are employed solely for distinguishing one component from another; the nature, order, or sequence of the components is not limited by those terms.

When a component is described as being “connected,” “coupled,” or “joined” to another component, the component may be directly connected or joined to the other component, or one or more intervening components may be present between the components.

The terms “comprises” and “comprising,” as used in the following description, do not exclude the presence or addition of one or more other components, steps, operations, or elements.

Prior to describing various features of the present disclosure, terminology used in the present disclosure will be explained.

In one or more aspects of the present disclosure, the term “mobile object” may refer to an object that autonomously drives or autonomously flies by applying an autonomous-driving algorithm. For example, the mobile object may include a vehicle, a drone, or a robot that moves on the basis of an autonomous-driving algorithm, but the present disclosure is not limited thereto. In the present disclosure, a “target mobile object” may be a virtual mobile object in simulation that moves by applying an autonomous-driving algorithm, and a “surrounding mobile object” may denote a virtual mobile object in simulation that is arranged around the target mobile object in order to evaluate the autonomous-driving algorithm.

In one or more aspects of the present disclosure, a “simulator” may be software and/or hardware that implements a virtual environment for simulating an autonomous-driving mobile object and simulates autonomous driving of the target mobile object in the virtual environment. The simulator may implement the virtual environment including a map, obstacles, pedestrians, and surrounding mobile objects and may perform autonomous-driving simulation for the target mobile object in the virtual environment. The simulator may autonomously drive a mobile object on the basis of an autonomous-driving algorithm. In addition, the simulator may determine a travel path of the mobile object on the basis of an autonomous-driving scenario and may simulate the travel.

Various features of the present disclosure will now be described in detail with reference to the accompanying drawings.

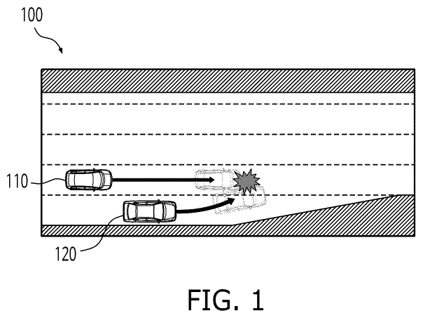

FIG. 1 illustrates a virtual environment 100 in which an autonomous-driving simulation is performed according to an example of the present disclosure. As illustrated in FIG. 1, the simulator may implement a virtual road on the basis of input data and may place a target mobile object 110 and a surrounding mobile object 120 on the virtual road. The simulator may move the target mobile object 110 and the surrounding mobile object 120 on the basis of a predetermined autonomous-driving algorithm. FIG. 1 illustrates the target mobile object 110 and the surrounding mobile object 120 as vehicle-shaped virtual objects. FIG. 1 also illustrates that the target mobile object 110 and the surrounding mobile object 120 autonomously drive on the basis of a scenario in which a collision may occur, but the present disclosure is not limited thereto.

According to an example, virtual objects having different sizes or shapes for respective vehicle models may be stored in the simulator. The simulator may extract a model of the target mobile object 110 contained in the input data and may select, from among a plurality of stored virtual objects, a virtual object associated with the extracted target mobile object as the object corresponding to the target mobile object 110.

The simulator may load a map including a virtual road and obstacles on the basis of the input data and may thereby generate a three-dimensional virtual environment in which the target mobile object 110 is simulated. The obstacles may include a parked vehicle, a traffic cone, a puddle, an accident vehicle, falling rocks, and the like. In addition, the simulator may implement pedestrian movement in the virtual environment on the basis of the input data.

As described above, on the basis of the input data input to the simulator, a virtual environment may be generated, and autonomous driving of the target mobile object 110 may be simulated in the virtual environment.

Various organizations, companies, and research institutes as well as ASAM may distribute a variety of scenario files. In this case, the data format contained in a scenario file may not be compatible with the data format of the simulator. In such a case, follow-up work such as manually converting the data contained in the scenario file to conform to the data specification that is input to the simulator, or redesigning the simulator to conform to the specification of the scenario file, may be required. Such follow-up work may require considerable cost and time.

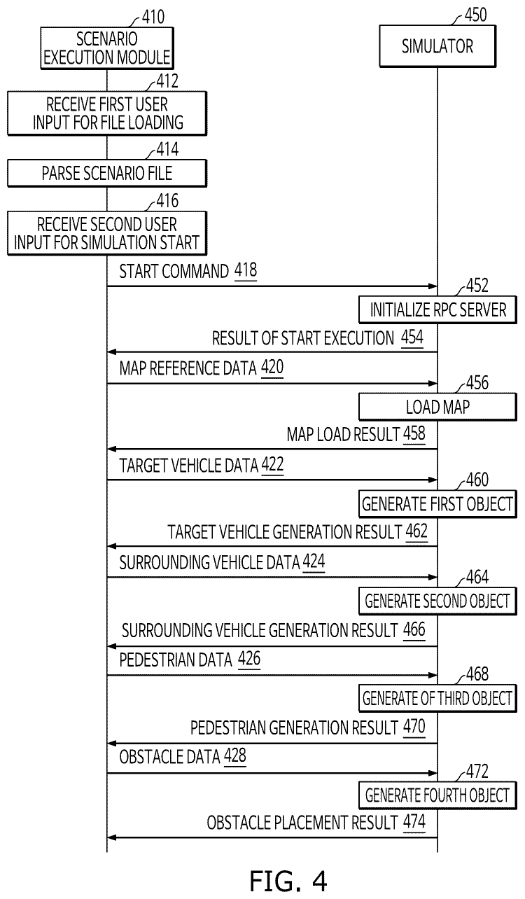

According to an example of the present disclosure, on the basis of the data format input to the simulator, the data contained in the scenario file may be parsed, and at least one piece of data input to the simulator may be generated automatically on the basis of the parsed data. To this end, as will be described below, a scenario execution module may be included in a computing device and/or an information-processing system. A method of inputting data extracted from the scenario file into the simulator will be described in detail with reference to FIG. 4.

In addition, a first thread may be created in the scenario execution module to acquire state information of a mobile object from the simulator. A second thread may be created in the scenario execution module to control the state of the mobile object in real time. Methods in which the first thread and the second thread are used to acquire the state information of the mobile object and to control the mobile object will be described below with reference to FIGS. 4 through 7.

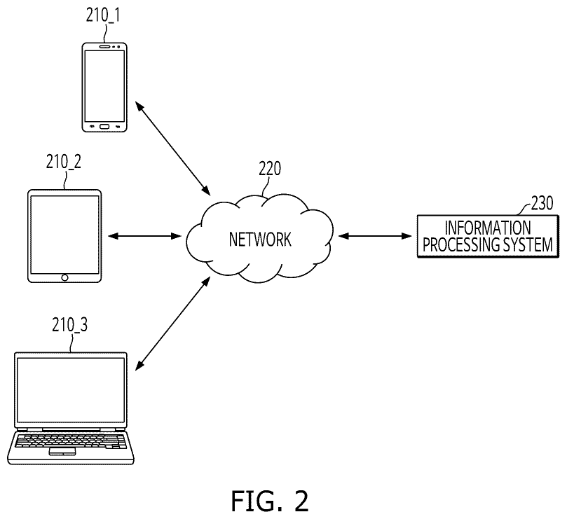

FIG. 2 is a schematic diagram showing a configuration in which an information-processing system 230 is communicatively connected with multiple user terminals 210_1, 210_2, and 210_3 according to an example of the present disclosure. As illustrated, the plurality of user terminals 210_1, 210_2, and 210_3 may be connected, through a network 220, to an information-processing system 230 that can execute an autonomous-driving simulation or provide a program related to an autonomous-driving simulation.

In an example, the information-processing system 230 may include one or more server devices and/or databases capable of storing, providing, and executing computer-executable programs (for example, downloadable applications) and data, or may include one or more distributed computing devices and/or distributed databases based on a cloud-computing service. Data related to the autonomous-driving simulation executed by the information-processing system 230 may be provided to users through autonomous-driving-simulation applications installed in the respective user terminals 210_1, 210_2, and 210_3. For example, the information-processing system 230 may receive data from the user terminals 210_1, 210_2, and 210_3 through such applications, and may process the received data. According to an example, the information-processing system 230 may include a simulator for autonomous driving.

The plurality of user terminals 210_1, 210_2, and 210_3 may communicate with the information-processing system 230 through the network 220. For example, the plurality of user terminals 210_1, 210_2, and 210_3 may transmit data to the information-processing system 230 through the network 220 or may receive data from the information-processing system 230. For instance, the plurality of user terminals 210_1, 210_2, and 210_3 may transmit, through the network 220, data to be input to the simulator, and may receive, from the information-processing system 230, simulation results performed by the simulator.

The network 220 may be configured to enable communication between the plurality of user terminals 210_1, 210_2, and 210_3 and the information-processing system 230. Depending on the installation environment, the network 220 may be composed of a wired network such as Ethernet, wired-home-network power-line communication, telephone-line communication, or RS-serial communication; a wireless network such as a mobile-communication network, WLAN wireless LAN, Wi-Fi, Bluetooth, or ZigBee; or a combination thereof. Communication methods are not limited thereto, and the network 220 may include not only communication methods that use communication networks included in the network 220 (for example, a mobile-communication network, a wired internet, a wireless internet, a broadcasting network, or a satellite network) but also short-range wireless communication among the user terminals 210_1, 210_2, and 210_3.

Although a mobile-phone terminal 210_1, a tablet terminal 210_2, and a PC terminal 210_3 are illustrated as examples of the user terminals in FIG. 2, the present disclosure is not limited thereto. The user terminals 210_1, 210_2, and 210_3 may be any computing devices capable of wired and/or wireless communication and capable of executing an application or a web browser. For example, the user terminal may include a smartphone, a mobile phone, a navigation device, a computer, a notebook, a digital-broadcast terminal, a personal digital assistant PDA, a portable multimedia player PMP, or a tablet PC. Although three user terminals 210_1, 210_2, and 210_3 are illustrated as communicating with the information-processing system 230 through the network 220 in FIG. 2, the present disclosure is not limited thereto, and a different number of user terminals may be configured to communicate with the information-processing system 230 through the network 220.

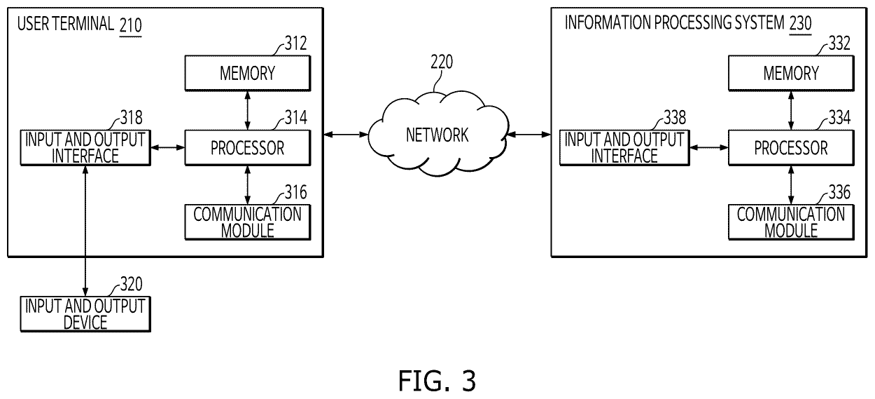

FIG. 3 is a block diagram illustrating internal configurations of the user

terminal 210 and the information-processing system 230 according to an example of the present disclosure. The user terminal 210 may denote any computing device capable of executing an application related to an autonomous-driving simulation and capable of wired or wireless communication, and may include, for example, the mobile-phone terminal 210_1, the tablet terminal 210_2, or the PC terminal 210_3 illustrated in FIG. 2.

As illustrated, the user terminal 210 may include a memory 312, a processor 314, a communication module 316, and an input/output interface 318. Similarly, the information-processing system 230 may include a memory 332, a processor 334, a communication module 336, and an input/output interface 338. As illustrated in FIG. 3, the user terminal 210 and the information-processing system 230 may be configured to communicate information and/or data through the network 220 via their respective communication modules 316 and 336. In addition, an input/output device 320 may be configured to input information and/or data to the user terminal 210 or to output information and/or data generated by the user terminal 210 through the input/output interface 318.

The memories 312 and 332 may include any non-transitory computer-readable recording medium. According to an example, the memories 312 and 332 may include permanent mass-storage devices such as read-only memory (ROM), a disk drive, a solid-state drive (SSD), or flash memory. As another example, non-volatile mass-storage devices such as ROM, SSD, flash memory, or disk drives may be included in the user terminal 210 or information-processing system 230 as separate permanent storage devices distinct from the memories. The memories 312 and 332 may store an operating system and at least one program code (for example, code for autonomous-driving simulation).

These software components may be loaded from a computer-readable recording medium separate from the memories 312 and 332. The separate computer-readable recording medium may include a medium connectable directly to the user terminal 210 or the information-processing system 230, for example, a floppy drive, a disk, a tape, a DVD/CD-ROM drive, or a memory card. In another example, the software components may be loaded into the memories 312 and 332 through the communication modules rather than through a computer-readable recording medium. For example, at least one program may be loaded into the memories 312 and 332 on the basis of installation files provided by a file-distribution system that distributes installation files for developers or applications through the network 220.

The processors 314 and 334 may be configured to process commands of a computer program by performing basic arithmetic, logical, and input/output operations.

The commands may be provided to the processors 314 and 334 by the memories 312 and 332 or the communication modules 316 and 336. For example, the processors 314 and 334 may be configured to execute commands received according to program code stored in the memories 312 and 332.

The communication modules 316 and 336 may provide functions for the user terminal 210 and the information-processing system 230 to communicate with each other through the network 220, and may provide functions for the user terminal 210 and/or the information-processing system 230 to communicate with other user terminals or other systems (for example, a separate cloud system). For example, a request or data generated by the processor 314 of the user terminal 210 according to program code stored in the memory 312 may be delivered to the information-processing system 230 through the network 220 under the control of the communication module 316. Conversely, at least one of a control signal, a command, or data provided under the control of the processor 334 of the information-processing system 230 may pass through the communication module 336 and the network 220 and be received by the user terminal 210 through the communication module 316.

The input/output interface 318 may provide a means for interfacing with the input/output device 320. For example, the input device may include a camera having an audio sensor and/or an image sensor, a keyboard, a microphone, or a mouse, and the output device may include a display, a speaker, or a haptic-feedback device. In another example, the input/output interface 318 may interface with a device integrated as a single component that performs both input and output, such as a touchscreen. For example, as the processor 314 of the user terminal 210 processes commands of a computer program loaded in the memory 312, a service screen (for example, a service screen for autonomous-driving simulation) configured using information and/or data provided by the information-processing system 230 or another user terminal may be displayed on a display through the input/output interface 318. In FIG. 3, the input/output device 320 is illustrated as not being included in the user terminal 210, but the present disclosure is not limited thereto, and the input/output device 320 may be configured integrally with the user terminal 210. The input/output interface 338 of the information-processing system 230 may interface with an input or output device (not illustrated) connected to or included in the information-processing system 230. Although the input/output interfaces 318 and 338 are illustrated as components separate from the processors 314 and 334, the input/output interfaces 318 and 338 may be configured to be included in the processors 314 and 334.

The user terminal 210 and the information-processing system 230 may include more components than those illustrated in FIG. 3. However, it is unnecessary to illustrate most conventional components in detail. In an example, the user terminal 210 may be implemented to include at least some of the above-described input/output devices 320. In addition, the user terminal 210 may further include other components such as a transceiver, a global positioning system GPS module, a camera, various sensors, or a database.

The processor 314 of the user terminal 210 may be configured to manage,

process, and/or store information and/or data received from the input/output device 320, another user terminal, the information-processing system 230, and/or a plurality of external systems. The information and/or data processed by the processor 314 may be provided to the information-processing system 230 through the communication module 316 and the network 220. The processor 314 of the user terminal 210 may transmit information and/or data to the input/output device 320 through the input/output interface 318 so that the information and/or data may be output. For example, by outputting the received information and/or data, the processor 314 may control a display included in or connected to the user terminal 210 so that the received information and/or data are displayed on a screen of the user terminal 210.

The processor 334 of the information-processing system 230 may be configured to manage, process, and/or store information and/or data received from the plurality of user terminals 210 and/or a plurality of external systems. The information and/or data processed by the processor 334 may be provided to the user terminals 210 through the communication module 336 and the network 220.

According to an example, a scenario execution module and/or the simulator described below may be included in the processor 334 of the information-processing system 230 or the processor 314 of the user terminal 210. For example, the scenario execution module and the simulator may be included in the processor 314 of the user terminal 210. In another example, the scenario execution module and the simulator may be included in the processor 334 of the information-processing system 230. In still another example, the scenario execution module may be included in the processor 314 of the user terminal 210, and the simulator may be included in the processor 334 of the information-processing system 230. That is, the scenario execution module and the simulator may be included in the same device or system, or each of the scenario execution module and the simulator may be included in different devices or systems.

FIG. 4 is a flowchart illustrating a method in which a virtual environment for autonomous-driving simulation is generated through a simulator 450 according to an example of the present disclosure. The scenario execution module 410 may receive a first user input 412 for file loading.

Thereafter, the scenario execution module 410 may load a scenario file (for example, an OpenSCENARIO file), parse the data contained in the scenario file on the basis of the data format input to the simulator 450, and extract a plurality of data from the scenario file 414. The first user input may include a scenario-file identifier (e.g., a file name) selected by the user from among a list of scenario files, and in that case the scenario execution module 410 may load and parse the scenario file associated with the scenario-file identifier. The scenario execution module 410 may generate a plurality of input data that are to be input to the simulator 450 on the basis of the extracted plurality of data. The plurality of input data may include reference data associated with map data (hereinafter referred to as “map reference data”), target mobile-object data, surrounding mobile-object data, pedestrian data, and obstacle data.

According to an example, the map reference data may be associated with a virtual road and a virtual sidewalk that are loaded by the simulator 450. For example, the map data may include a GNSS (Global Navigation Satellite System) coordinate range or may include a map name that is to be loaded into the simulator 450.

According to an example, the target mobile-object data may include data associated with autonomous driving of the target mobile object. For example, the target mobile-object data may include a driving path of the target mobile object, a driving time, and sensor-position information. The sensor-position information may include a position of a first sensor related to LIDAR arranged in the target mobile object, a position of a second sensor related to GNSS, and/or a position of a third sensor related to a camera.

In addition, the surrounding mobile-object data may include data associated with autonomous driving of a surrounding mobile object. For example, the surrounding mobile-object data may include a driving path of the surrounding mobile object, a driving time, and sensor-position information. The sensor-position information may include a position of a first sensor related to LIDAR arranged in the surrounding mobile object, a position of a second sensor related to GNSS, and/or a position of a third sensor related to a camera. According to some implementations, multiple sets of surrounding mobile-object data may be generated.

The pedestrian data may include data associated with a pedestrian that is implemented virtually. For example, the pedestrian data may include a position of the pedestrian, a movement path, and a pedestrian-movement speed. According to some implementations, multiple sets of pedestrian data may be generated.

The obstacle data may include an obstacle type and a position. The obstacle type may denote a type of object that obstructs traffic on an actual road, such as a parked vehicle, a traffic cone, a puddle, a rock, or an accident vehicle. According to some implementations, multiple sets of obstacle data may be generated.

When parsing of the scenario file is completed, the scenario execution module 410 may receive a second user input 416 for initiating simulation. In response to receiving the second user input, the scenario execution module 410 may input a start command 418 into the simulator 450 to establish a communication connection with the simulator 450. For example, the scenario execution module 410 may call an Application Programming Interface (API) function for transmitting the start command 418 and may input the start command 418 into the simulator 450.

In response to receiving the start command 418, the simulator 450 may initialize a Remote Procedure Call (RPC) server 452 and may establish a communication connection with the scenario execution module 410 through the initialized RPC server. Thereafter, the simulator 450 may transmit a start-execution result 454 to the scenario execution module 410. The start-execution result 454 may include information indicating that the start command was processed normally.

In response to receiving the start-execution result 454, the scenario execution module 410 may input map reference data 420 into the simulator 450. For example, the scenario execution module 410 may call an API function for transmitting the map reference data 420 and may input the map reference data 420 into the simulator 450. The map reference data 420 may include a map name or a coordinate range related to a map that is to be loaded into the simulator 450.

Thereafter, the simulator 450 may load a map including a virtual road and a virtual sidewalk on the basis of the input map reference data 420 456. For example, the map reference data 420 may include a GNSS coordinate range, and the simulator 450 may extract and load, from an entire map in which virtual roads and virtual sidewalks are stored, the portion corresponding to the GNSS coordinate range. In another example, the map reference data 420 may include a map name, and the simulator 450 may load, from among a plurality of stored maps, the map associated with the map name.

When loading of the map is completed, the simulator 450 may transmit a map-load result 458 to the scenario execution module 410. The map-load result 458 may include information indicating that the map has been successfully loaded.

In response to receiving the map-load result 458, the scenario execution module 410 may input target mobile-object data 422 into the simulator 450. For example, the scenario execution module 410 may call an API function for inputting the target mobile-object data 422 and may input the target mobile-object data 422 into the simulator 450.

The simulator 450 may generate a virtual first object associated with the target mobile object on the basis of the input target mobile-object data 422 and may place the virtual first object on the virtual road 460. According to an example, the simulator 450 may generate the virtual first object associated with the target mobile object and place the virtual first object on the virtual road on the basis of a start position of the driving path (e.g., a GNSS coordinate) included in the target mobile-object data 422. Thereafter, the simulator 450 may move the virtual first object associated with the target mobile object on the virtual road on the basis of the driving path included in the target mobile-object data 422. That is, the target mobile-object data 422 may enable autonomous driving on the virtual road on the basis of a driving scenario included in the target mobile-object data 422. The driving scenario may be associated with a driving speed or a driving path. Thereafter, the simulator 450 may transmit a target-mobile-object creation result 462 to the scenario execution module 410.

In response to receiving the target-mobile-object creation result 462, the scenario execution module 410 may input surrounding mobile-object data 424 into the simulator 450. For example, the scenario execution module 410 may call an API function for inputting the surrounding mobile-object data 424 and may input the surrounding mobile-object data 424 into the simulator 450.

The simulator 450 may generate a virtual second object associated with a surrounding mobile object on the basis of the input surrounding mobile-object data 424 and may place the virtual second object on the virtual road 464. According to an example, the simulator 450 may generate the virtual second object associated with the surrounding mobile object and place the virtual second object on the virtual road on the basis of a start position of the driving path (e.g., a GNSS coordinate) included in the surrounding mobile-object data 424. Thereafter, the simulator 450 may move the virtual second object associated with the surrounding mobile object on the virtual road on the basis of the driving path included in the surrounding mobile-object data 424. That is, the surrounding mobile-object data 424 may enable autonomous driving on the virtual road on the basis of a driving scenario included in the surrounding mobile-object data 424. Thereafter, the simulator 450 may transmit a surrounding-mobile-object creation result 466 to the scenario execution module 410.

Meanwhile, the scenario execution module 410 may input multiple sets of surrounding mobile-object data into the simulator 450. In that case, the simulator 450 may generate virtual second objects in the number of surrounding mobile-object data and may place them on the virtual road.

In response to receiving the surrounding-mobile-object creation result 466, the scenario execution module 410 may input pedestrian data 426 into the simulator 450. For example, the scenario execution module 410 may call an API function for inputting the pedestrian data 426 and may input the pedestrian data 426 into the simulator 450. The simulator 450 may generate a virtual third object associated with a

pedestrian on the basis of the input pedestrian data 426 and may place the virtual third object on the virtual sidewalk 468. According to an example, the simulator 450 may generate the virtual third object associated with the pedestrian and place the virtual third object on the virtual road on the basis of a start position of the movement path (e.g., a GNSS coordinate) included in the pedestrian data 426. Thereafter, the simulator 450 may move the virtual third object on the virtual road on the basis of the movement path included in the pedestrian data 426. Thereafter, the simulator 450 may transmit a pedestrian-creation result 470 to the scenario execution module 410.

Meanwhile, the scenario execution module 410 may input multiple sets of pedestrian data into the simulator 450. In that case, the simulator 450 may generate virtual third objects in the number of pedestrian data, and may place them on the virtual sidewalk.

In response to receiving the pedestrian generation results 470, the scenario execution module 410 may input obstacle data 428 into the simulator 450. For example, the scenario execution module 410 may call an API function for inputting the obstacle data 428 and may input the obstacle data 428 into the simulator 450.

The simulator 450 may generate a virtual fourth object associated with an obstacle on the basis of the input obstacle data 428 and may place the virtual fourth object on at least one of a virtual sidewalk and a virtual road 472. That is, when the obstacle data 428 are input to the simulator 450, the virtual fourth object associated with the obstacle may be generated. According to an example, the simulator 450 may determine a shape and a size of the fourth object on the basis of a size and a type of the obstacle included in the obstacle data 428 and may place the fourth object on at least one of the virtual sidewalk and the virtual road on the basis of a position of the obstacle included in the obstacle data 428. Thereafter, the simulator 450 may transmit an obstacle-placement result 474 to the scenario execution module 410.

Meanwhile, the scenario execution module 410 may input multiple sets of obstacle data into the simulator 450. In that case, the simulator 450 may generate virtual fourth objects in the number of the obstacle data, and may place them on the virtual sidewalk and/or the virtual road.

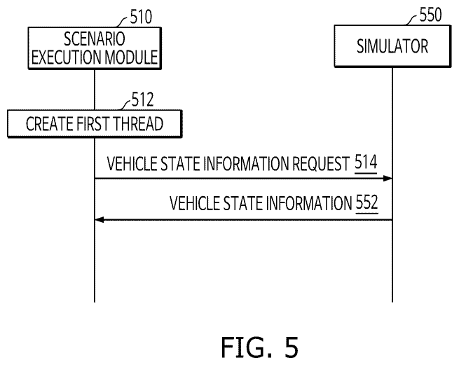

FIG. 5 is a flowchart illustrating a method in which state information of a mobile object is acquired through a first thread according to an example of the present disclosure. The scenario execution module 510 may generate a first thread in order to acquire state information of a mobile object 512.

Thereafter, the first thread generated by the scenario execution module 510 may transmit a request 514 for state information about the target mobile object to the simulator 550.

Thereafter, the simulator 550 may extract state information about the target mobile object being simulated for autonomous driving and may transmit the extracted state information 552 about the target mobile object to the scenario execution module 510. That is, the scenario execution module 510 may receive, through the first thread, the state information 552 about the target mobile object from the simulator 550. Computing resources CPU, memory, disk, and the like for autonomous-driving

simulation may be allocated to the scenario execution module 510, and the first thread may transmit the state-information request 514 for the mobile object to the simulator 550 by using some or all of the computing resources allocated to the scenario execution module 510 and may receive the state information 552 about the target mobile object from the simulator 550. The state information about the target mobile object may include sensing information of each sensor included in the target mobile object, a steering angle, a speed, braking information, a position, and the like.

The request for the state information about the target mobile object may be transmitted to the simulator 550 at regular periodic intervals. According to an example, the first thread created by the scenario execution module 510 may repeatedly transmit, at a predetermined interval, the state-information request 514 for the target mobile object to the simulator 550 and, in response, may receive the state information 556 about the target mobile object from the simulator 550 at a predetermined periodic interval.

Meanwhile, the first thread created by the scenario execution module 510 may transmit a request for state information about a surrounding mobile object to the simulator 550. In that case, the simulator 550 may extract state information about the surrounding mobile object being simulated and may transmit the extracted state information about the surrounding mobile object to the scenario execution module 510. The state information about the surrounding mobile object may include sensing information of each sensor arranged in the surrounding mobile object, a steering angle, a speed, braking information, a position, and the like. According to an example, the first thread created by the scenario execution module 510 may repeatedly transmit, at a predetermined interval, the request for the state information about the surrounding mobile object to the simulator 550 and, in response, may receive the state information about the surrounding mobile object from the simulator 550 at a predetermined periodic interval.

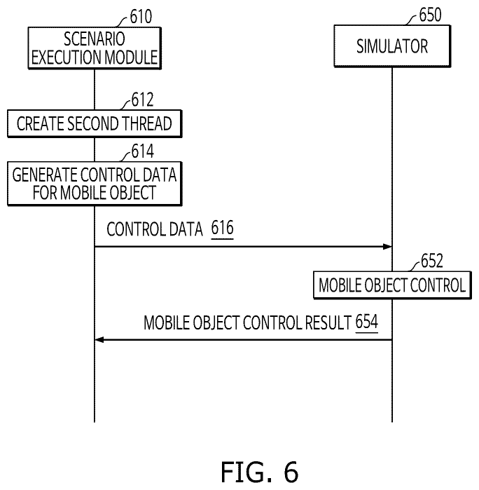

FIG. 6 is a flowchart illustrating a method in which a mobile object is controlled through a second thread according to an example of the present disclosure. The scenario execution module 610 may create a second thread 612 in order to control a state of the mobile object.

Next, the second thread created by the scenario execution module 610 may generate control data for controlling the target mobile object 614. The control data may be data for changing driving of the target mobile object, such as changing a speed of the target mobile object, braking the target mobile object, or changing a lane of the target mobile object. The control data may be generated on the basis of user input or may be generated automatically on the basis of a predetermined control algorithm.

Thereafter, the second thread created by the scenario execution module 610 may input the generated control data 616 into the simulator 650. For example, an API function for inputting the control data 616 may be called, and the control data 616 may be input to the simulator 650. Computing resources CPU, memory, disk, and the like to perform the autonomous-driving simulation may be allocated to the scenario execution module 610, and the second thread may generate the control data 616 by using some or all of the computing resources allocated to the scenario execution module 610 and may transmit the control data 616 to the simulator 650. That is, the scenario execution module 610 may input the control data 616 into the simulator 650 through the second thread.

The simulator 650 may change movement of an autonomously driven virtual first object associated with the target mobile object on the basis of the control data 616. Accordingly, the target mobile object being simulated for autonomous driving may be controlled 652 on the basis of the control data 616. Thereafter, the simulator 650 may transmit a control result 654 for the target mobile object to the scenario execution module 610. The control result 654 may include information indicating that control of the target mobile object has been successfully completed.

Meanwhile, the second thread created in the scenario execution module 610 may generate control data for controlling a surrounding mobile object and may input the control data into the simulator 650. In that case, the simulator 650 may change a driving state of a virtual second object associated with the surrounding mobile object on the basis of the received control data, and accordingly the surrounding mobile object being simulated for autonomous driving may be controlled.

According to an example of the present disclosure, state information about the target mobile object and/or the surrounding mobile object controlled on the basis of the control data may be acquired through the first thread. For example, the scenario execution module 610 may receive, through the first thread, state information of the target mobile object and/or the surrounding mobile object whose movement has been changed on the basis of the control data. On the basis of the received state information of the target mobile object and/or the surrounding mobile object, a correlation between the control data and the driving of the mobile object may be analyzed.

Meanwhile, multiple sets of sudden-situation data capable of causing an accident may be stored in advance in a computing device and/or an information-processing system. In that case, on the basis of the sudden-situation data, a mobile object being simulated for autonomous driving may be controlled. Here, a sudden situation may be a high-accident-probability situation such as a surrounding mobile object suddenly cutting in, the target mobile object suddenly changing lanes, or a mobile object in front of the target mobile object suddenly braking hard. That is, the sudden-situation data may be data for artificially generating such high-accident-probability situations and may include control data for the target mobile object and control data for the surrounding mobile object.

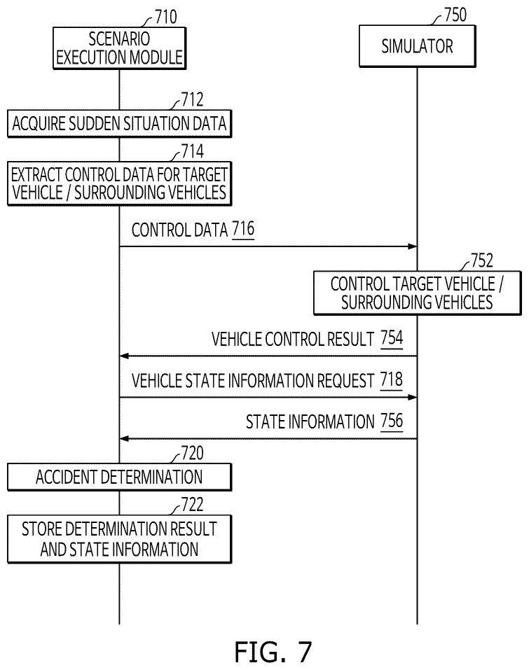

FIG. 7 is a flowchart illustrating a method in which a mobile object is controlled on the basis of sudden-situation data according to an example of the present disclosure. The scenario execution module 710 may acquire sudden-situation (or unexpected situation) data 712. The sudden-situation data may be stored in advance in a computing device or an information-processing system that includes the scenario execution module 710, or may be acquired from an external device.

Thereafter, the second thread created by the scenario execution module 710 may extract first control data for the target mobile object and second control data for the surrounding mobile object that are included in the sudden-situation data 714. The first control data may be data for controlling movement of the target mobile object and may include data associated with changing a speed of the target mobile object, data associated with braking the target mobile object, and/or data associated with changing a lane of the target mobile object. In addition, the second control data may be data for controlling movement of the surrounding mobile object and may include data associated with changing a speed of the surrounding mobile object, data associated with braking the surrounding mobile object, and/or data associated with changing a lane of the surrounding mobile object. When the target mobile object moves on the basis of the first control data and the surrounding mobile object moves on the basis of the second control data, a sudden situation targeting the target mobile object may occur.

The second thread created by the scenario execution module 710 may input the first control data 716 and the second control data 716 into the simulator 750. In that case, the simulator 750 may change movement of a virtual first object associated with the target mobile object and currently autonomously driven on the basis of the first control data 716. Accordingly, the target mobile object being simulated for autonomous driving may be controlled 752 in real time on the basis of the first control data 716. In addition, the simulator 750 may change movement of a virtual second object associated with the surrounding mobile object and currently autonomously driven on the basis of the second control data 716. The surrounding mobile object being simulated for autonomous driving may be controlled 752 in real time on the basis of the second control data 716.

As described above, when movement of the target mobile object being simulated for autonomous driving is controlled on the basis of the first control data 716 and movement of the target mobile object being simulated for autonomous driving is controlled on the basis of the second control data 716, the target mobile object may encounter a sudden situation. In that case, on the basis of an autonomous-driving algorithm applied to the target mobile object, the target mobile object may attempt to drive in a manner that avoids the sudden situation. A method of avoiding such a sudden situation may be simulated by the simulator on the basis of a pre-generated autonomous-driving algorithm.

Thereafter, the simulator 750 may transmit target/surrounding mobile-object control results 754 to the scenario execution module 710. The mobile-object control results 754 may include information indicating that control of the target mobile object and the surrounding mobile object has been successfully completed.

Next, the first thread created by the scenario execution module 710 may transmit a request 718 for state information about the target mobile object and the surrounding mobile objects to the simulator. Thereafter, the simulator 750 may extract respective state information about the target mobile object and the surrounding mobile objects that are being simulated for autonomous driving and may transmit the extracted state information 756 to the scenario execution module 710. The state information about the target mobile object may include sensing information, a steering angle, a speed, braking information, a position, and whether a collision occurred, and the state information about the surrounding mobile objects may include sensing information, a steering angle, a speed, braking information, a position, and whether a collision occurred.

The scenario execution module 710 may determine, on the basis of the received state information for each of the target mobile object and the surrounding mobile objects, whether an accident involving the target mobile object has occurred 720. For example, whether an accident occurred with the target mobile object may be determined on the basis of whether a collision occurred, which is included in the state information of the target mobile object.

Subsequently, the scenario execution module 710 may store, in association, an accident-determination result and the received state information of the target mobile object and the surrounding mobile objects 722. Additionally, immediately before transmitting the first control data 716 and the second control data 716, the scenario execution module 710 may store, in association with the accident-determination result and the received state information of the target mobile object and the surrounding mobile objects, the state information of the target mobile object and the surrounding mobile objects that was received through the first thread. That is, the state information of the target/surrounding mobile objects immediately before the sudden situation and the state information of the target/surrounding mobile objects immediately after the sudden situation may be stored together with the accident-determination result.

As described above, through use of the second thread, the target mobile object/surrounding mobile objects may be controlled in real time while the autonomous-driving simulation based on the scenario file is being executed. In addition, state information of the target mobile object/surrounding mobile objects whose movement has been changed through the first thread may be quickly acquired.

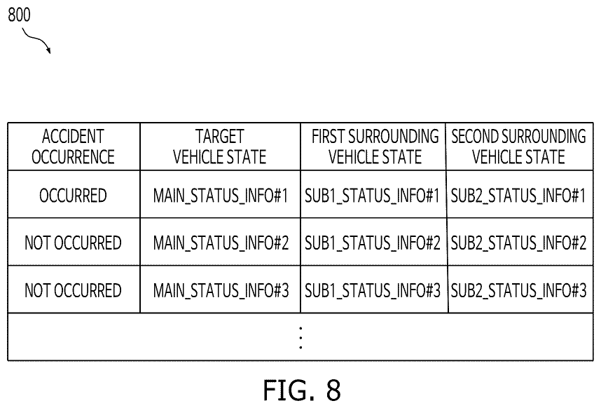

FIG. 8 illustrates state information 800 of a mobile object generated on the basis of a sudden situation. After a target mobile object and/or a surrounding mobile object is controlled on the basis of a sudden situation, state information 800 such as that shown in FIG. 8 may be acquired and stored. In FIG. 8, one line is state information of a mobile object acquired on the basis of one set of sudden-situation data. FIG. 8 illustrates that the top line is associated with sudden-situation data resulting in an accident, and the second and third lines are associated with sudden-situation data in which an accident did not occur.

According to an example, a target-mobile-object-state field may record state information of the target mobile object. The state information of the target mobile object may include the state information of the target mobile object immediately before a sudden situation and the state information of the target mobile object immediately after the sudden situation. A first-surrounding-mobile-object-state field may record state information of a first surrounding mobile object. The state information of the first surrounding mobile object may include the state information of the first surrounding mobile object immediately before the sudden situation and the state information of the first surrounding mobile object immediately after the sudden situation. A second-surrounding-mobile-object-state field may record state information of a second surrounding mobile object. The state information of the second surrounding mobile object may include the state information of the second surrounding mobile object immediately before the sudden situation and the state information of the second surrounding mobile object immediately after the sudden situation.

Such state information associated with sudden situations may later be used to improve an autonomous-driving algorithm. For example, by using sudden-situation data associated with an accident, the state information of the target mobile object, and the state information of the surrounding mobile objects, the autonomous-driving algorithm may be improved in a direction that avoids accidents.

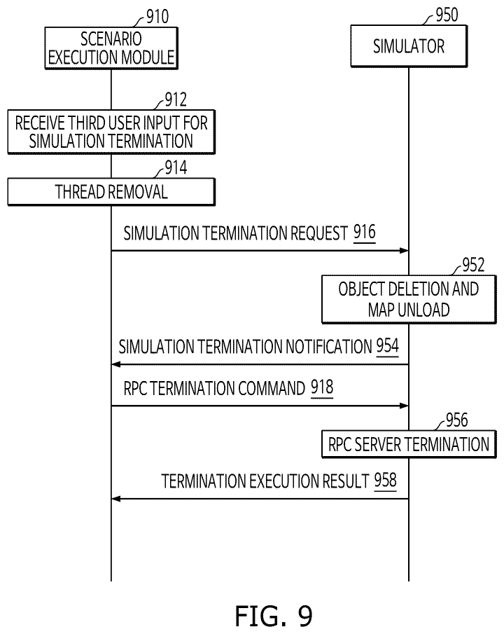

FIG. 9 is a flowchart illustrating a method in which an autonomous-driving

simulation is terminated according to an example of the present disclosure. The scenario execution module 910 may receive a third user input 912 for terminating the simulation. In response to receiving the third user input, the scenario execution module 910 may remove the first thread and the second thread 914.

Thereafter, the scenario execution module 910 may transmit a simulation-termination request 916 to the simulator 950. For example, the scenario execution module 910 may call an API function for transmitting a simulation-stop request 916, which results in inputting the simulation-termination request 916 into the simulator 950.

In response to the simulation-termination request 916, the simulator 950 may delete all objects placed on the map and may unload the loaded map 952. Thereafter, the simulator 950 may transmit a simulation-termination notification 954 to the scenario execution module 910.

In response to receiving the simulation-termination notification 954, the scenario execution module 910 may input an RPC termination command 918 into the simulator 950. For example, the scenario execution module 910 may call an API function associated with the RPC termination command 918 and may input the RPC termination command 918 into the simulator 950.

In response to receiving the RPC termination command 918, the simulator 950 may terminate the RPC server that is running 956. Thereafter, the simulator 950 may transmit a termination-execution result 958 to the scenario execution module 910. The termination-execution result 958 may include information indicating that the RPC stop command has been successfully processed.

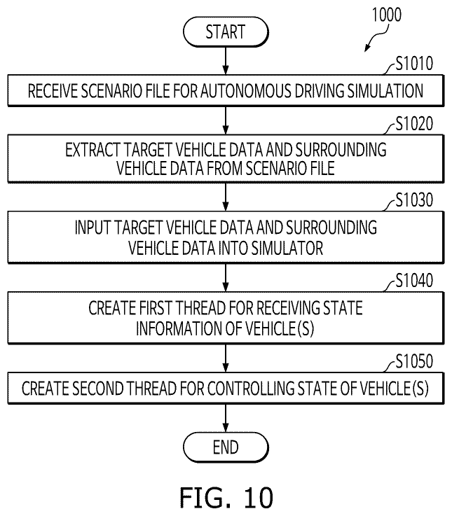

FIG. 10 is a flowchart illustrating a simulation method 1000 for an autonomous-driving mobile object according to an example of the present disclosure. The method 1000 illustrated in FIG. 10 is merely an example for achieving the object of the present disclosure, and some steps may be added, deleted, or reordered if necessary. The method 1000 illustrated in FIG. 10 may be performed by at least one processor included in a computing device (for example, a user terminal) and/or an information-processing system. For convenience of explanation, each step illustrated in FIG. 10 will be described as being performed by the scenario execution module included in the user terminal or the information-processing system illustrated in FIG. 3. The scenario execution module may be included in at least one process.

In step S1010, the scenario execution module may receive a scenario file for autonomous-driving simulation.

Thereafter, in step S1020, the scenario execution module may extract target mobile-object data and surrounding mobile-object data used for the autonomous-driving simulation from the received scenario file. According to an example, the scenario execution module may parse respective data included in the scenario file on the basis of the data format input to the simulator, and may extract the target mobile-object data and the surrounding mobile-object data from the parsed data.

Next, in S1030, the scenario execution module may input the target mobile-object data and the surrounding mobile-object data into the simulator so that a target mobile object to be tested and surrounding mobile objects are driven by the simulator.

Thereafter, in S1040, the scenario execution module may create a first thread for receiving state information of at least one of the target mobile object and the surrounding mobile objects from the simulator. Subsequently, through the created first thread, the scenario execution module may receive state information about the target mobile object at predetermined periodic intervals.

Next, in S1050, the scenario execution module may create a second thread for controlling a state of at least one of the target mobile object and the surrounding mobile objects. Subsequently, through the created second thread, the scenario execution module may input first control data for controlling the target mobile object into the simulator. Subsequently, through the created first thread, the scenario execution module may receive, from the simulator, state information of the target mobile object controlled on the basis of the first control data.

According to an example, autonomous driving of the target mobile object may be simulated by the simulator using an autonomous-driving algorithm.

According to an example, the scenario execution module may extract map reference data used for the autonomous-driving simulation from the scenario file and may input the extracted map reference data into the simulator so that a virtual road associated with the map reference data is loaded by the simulator.

In addition, the scenario execution module may extract at least one of pedestrian data or obstacle data used for the autonomous-driving simulation from the scenario file. The scenario execution module may input at least one of the extracted pedestrian data or obstacle data into the simulator so that at least one of a pedestrian associated with the pedestrian data or an obstacle associated with the obstacle data is loaded by the simulator.

According to an example, before inputting data into the simulator, the scenario execution module may establish a communication connection with the simulator in response to receiving user input for initiating the simulation.

Meanwhile, the scenario execution module may extract second control data for controlling the target mobile object and third control data for controlling the surrounding mobile objects from sudden-situation data. The scenario execution module may then input the second control data and the third control data into the simulator through the created second thread and may receive, through the created first thread, state information of the target mobile object controlled on the basis of the second control data and state information of the surrounding mobile objects controlled on the basis of the third control data from the simulator.

The scenario execution module may subsequently determine, on the basis of the state information of the target mobile object and the state information of the surrounding mobile objects, whether an accident involving the target mobile object occurred, and may store, in association, a result of the determined accident occurrence, the state information of the target mobile object, and the state information of the surrounding mobile objects.

The above flowchart and the above description are merely examples, and some features may be implemented differently. For example, in some implementations, the order of the steps may be changed, some steps may be repeated, some steps may be omitted, or some steps may be added.

The above-described method may be provided as a computer program stored on a computer-readable recording medium for execution on a computer. The medium may permanently store the computer-executable program or may temporarily store it for execution or download. The medium may be any recording or storage means in which one or more items of hardware are combined, may be directly connected to a computer system, or may be distributed across a network. Examples of media include magnetic media such as hard disks, floppy disks, and magnetic tape; optical recording media such as CD-ROMs and DVDs; magneto-optical media such as a floptical disk; and media configured to store program instructions such as ROM, RAM, and flash memory. Other examples include recording or storage media managed by an app store distributing applications, or by various software-supply or distribution sites and servers.

The methods, operations, or techniques of the present disclosure may be implemented by various means. For example, such techniques may be implemented in hardware, firmware, software, or any combination thereof. Those of ordinary skill in the art will understand that various illustrative logical blocks, modules, circuits, and algorithm steps described in connection with the present disclosure may be implemented as electronic hardware, computer software, or combinations of both. To clearly describe this interchangeability between hardware and software, various illustrative components, blocks, modules, circuits, and steps have been described above in terms of their functionality. Whether such functionality is implemented as hardware or as software depends on design constraints imposed on the overall system and on particular applications. Those of ordinary skill in the art may implement the described functionality in various ways for each particular application, and such implementations should not be interpreted as departing from the scope of the present disclosure. In a hardware implementation, processing units used to perform the techniques may be implemented within one or more ASICs, DSPs, digital-signal-processing devices DSPDs, programmable logic devices PLDs, field-programmable gate arrays FPGAs, processors, controllers, microcontrollers, microprocessors, electronic devices, other electronic units designed to perform the functions described herein, computers, or combinations thereof.

Accordingly, various illustrative logical blocks, modules, and circuits described in connection with the present disclosure may be implemented or performed in any combination of general-purpose processors, DSPs, ASICs, FPGAs or other programmable logic devices, discrete gate or transistor logic, discrete hardware components, or any combination of devices designed to perform the functions described herein. A general-purpose processor may be a microprocessor, but, in the alternative, the processor may be any conventional processor, controller, microcontroller, or state machine. The processor may also be implemented as a combination of computing devices, for example, a combination of a DSP and a microprocessor, multiple microprocessors, one or more microprocessors in conjunction with a DSP core, or any other such configuration.

In a firmware and/or software implementation, the techniques may be implemented as instructions stored on a computer-readable medium such as RAM, ROM, non-volatile RAM NVRAM, PROM, EPROM, EEPROM, flash memory, a compact disc CD, or a magnetic or optical data-storage device. The instructions may be executed by one or more processors and may cause the processor(s) to perform certain aspects of the functionality described herein.

When implemented in software, the above-described techniques may be stored on or transmitted via a computer-readable medium as one or more instructions or codes. Computer-readable media include both storage media and communication media and encompass any medium that facilitates transfer of a computer program from one place to another. Storage media may be any available medium that can be accessed by a computer. Non-limiting examples of computer-readable media include RAM, ROM, EEPROM, CD-ROM or other optical-disk storage, magnetic-disk storage or other magnetic-storage devices, or any other medium that can be used to carry or store desired program code in the form of instructions or data structures and that can be accessed by a computer. Any connection is properly termed a computer-readable medium.

For example, when software is transmitted from a website, server, or other remote source using a coaxial cable, fiber-optic cable, twisted pair, digital subscriber line DSL, or infrared, radio, and microwave wireless technologies, the coaxial cable, fiber-optic cable, twisted pair, DSL, or infrared, radio, and microwave wireless technologies are included within the definition of the medium. As used herein, the term “disk” and “disc” include compact discs CD, laser discs, optical discs, digital versatile discs DVD, floppy disks, and Blu-ray discs, where disks generally reproduce data magnetically, while discs reproduce data optically with lasers. Combinations of the above should also be included within the scope of computer-readable media.

Software modules may reside in RAM memory, flash memory, ROM memory, EPROM memory, EEPROM memory, registers, a hard disk, a removable disk, a CD-ROM, or any other form of known storage medium. An exemplary storage medium may be coupled to the processor so that the processor can read information from and write information to the storage medium. Alternatively, the storage medium may be integral to the processor. The processor and the storage medium may reside together in an ASIC. The ASIC may reside in a user terminal. Alternatively, the processor and the storage medium may reside as discrete components in a user terminal.

While the above-described features have been described as utilizing aspects of the present subject matter in one or more stand-alone computer systems, the present disclosure is not limited thereto and may be implemented in connection with any computing environment, such as a network or distributed-computing environment. Furthermore, aspects of the subject matter described herein may be implemented on multiple processing chips or devices, and storage may likewise be effected across multiple devices. Such devices may include PCs, network servers, and portable devices.

Although the present disclosure has been described in connection with certain examples, various modifications and alterations can be made without departing from the scope of the present disclosure as understood by those of ordinary skill in the art. Such modifications and alterations should be considered to fall within the scope of the appended claims.

### Effects

According to some aspects of the present disclosure, data included in a scenario file may be parsed on the basis of the data format input to the simulator, and at least one piece of data input to the simulator may be generated on the basis of the parsed data. Accordingly, various types of scenario files can be universally applied to the simulator without modifying the simulator design.

According to some aspects of the present disclosure, state information about a mobile object being simulated for autonomous driving may be acquired through the first thread, and the state of the mobile object being simulated for autonomous driving may be controlled through the second thread. Therefore, without being constrained by an autonomous-driving scenario already being executed in the simulator, the mobile object being autonomously driven can be controlled in real time when necessary, and the state information of the mobile object under real-time control can be obtained immediately.

According to some aspects of the present disclosure, a sudden situation surrounding a mobile object being simulated for autonomous driving can be artificially generated on the basis of sudden-situation data. The sudden situation can be repeatedly performed, and state information of each mobile object that responds to the sudden situation can be collected. The collected state information of each mobile object is used to improve the autonomous-driving algorithm, and accordingly, the performance of the autonomous-driving algorithm can be enhanced.

The effects of the present disclosure are not limited to those mentioned above, and other effects not mentioned will be clearly understood by those of ordinary skill in the art from the description of the claims.

What is claimed is:

1. A simulation method for an autonomous driving vehicle performed by an apparatus comprising at least one processor, the simulation method comprising:
receiving a scenario file for autonomous driving simulation;
extracting, from the received scenario file, target vehicle data and surrounding vehicle data for the autonomous driving simulation;
inputting the target vehicle data and the surrounding vehicle data into a simulator so that a target vehicle to be tested and surrounding vehicles are driven by the simulator;
creating a first thread for receiving state information of at least one of the target vehicle and the surrounding vehicles from the simulator; and
creating a second thread for controlling a state of at least one of the target vehicle and the surrounding vehicles,
wherein autonomous driving of the target vehicle is simulated by the simulator using an autonomous driving algorithm.

2. The simulation method for an autonomous driving vehicle as claimed in claim 1, further comprising:
before inputting the target vehicle data and the surrounding vehicle data into the simulator,
extracting reference data associated with map data used for the autonomous driving simulation from the scenario file; and
inputting the extracted reference data into the simulator so that a virtual road associated with the map data is loaded by the simulator.

3. The simulation method for an autonomous driving vehicle as claimed in claim 1, further comprising:
extracting at least one of pedestrian data and obstacle data used for the autonomous driving simulation from the scenario file; and
inputting the extracted at least one of pedestrian data and obstacle data into the simulator so that at least one of a pedestrian associated with the pedestrian data and an obstacle associated with the obstacle data is loaded by the simulator.

4. The simulation method for an autonomous driving vehicle as claimed in claim 1, further comprising:
before inputting the target vehicle data and the surrounding vehicle data into the simulator,
establishing a communication connection with the simulator in response to receiving a user input for initiating the simulation.

5. The simulation method for an autonomous driving vehicle as claimed in claim 1,
wherein extracting the target vehicle data and the surrounding vehicle data from the received scenario file comprises:
parsing respective data included in the scenario file based on a data format input to the simulator; and
extracting the target vehicle data and the surrounding vehicle data from the parsed data.

6. The simulation method for an autonomous driving vehicle as claimed in claim 1, further comprising:
after creating the first thread,
receiving, through the first thread, state information about the target vehicle from the simulator at predetermined periodic intervals.

7. The simulation method for an autonomous driving vehicle as claimed in claim 1, further comprising:
after creating the second thread,
inputting, through the second thread, first control data for controlling the target vehicle into the simulator; and
receiving, through the first thread, state information of the target vehicle controlled based on the first control data from the simulator.

8. The simulation method for an autonomous driving vehicle as claimed in claim 1, further comprising:
after creating the second thread,
extracting second control data for controlling the target vehicle and third control data for controlling the surrounding vehicles from sudden situation data;
inputting, through the second thread, the second control data and the third control data into the simulator; and
receiving, through the first thread, state information of the target vehicle controlled based on the second control data and state information of the surrounding vehicles controlled based on the third control data from the simulator.

9. The simulation method for an autonomous driving vehicle as claimed in claim 8, further comprising:
after receiving the state information of the surrounding vehicles from the simulator,
determining, based on the state information of the target vehicle and the state information the surrounding vehicles, whether an accident involving the target vehicle occurred; and
storing a result of the determined accident occurrence, the state information of the target vehicle, and the state information of the surrounding vehicles in association with each other.

10. A computer-readable non-transitory recording medium storing instructions that, when executed by a computer, are configured to cause:
receiving a scenario file for autonomous driving simulation;
extracting, from the received scenario file, target vehicle data and surrounding vehicle data for the autonomous driving simulation;
inputting the target vehicle data and the surrounding vehicle data into a simulator so that a target vehicle to be tested and surrounding vehicles are driven by the simulator;
creating a first thread for receiving state information of at least one of the target vehicle and the surrounding vehicles from the simulator; and
creating a second thread for controlling a state of at least one of the target vehicle and the surrounding vehicles,
wherein autonomous driving of the target vehicle is simulated by the simulator using an autonomous driving algorithm.

11. An apparatus comprising:
a memory; and
at least one processor connected to the memory and configured to execute at least one computer-readable program stored in the memory,
wherein the at least one computer-readable program comprises instructions configured to cause the apparatus to:
receive a scenario file for autonomous driving simulation;
extract, from the received scenario file, target vehicle data and surrounding vehicle data for the autonomous driving simulation;
input the target vehicle data and the surrounding vehicle data into a simulator so that a target vehicle to be tested and surrounding vehicles are driven by the simulator;
create a first thread for receiving state information of at least one of the target vehicle and the surrounding vehicles from the simulator; and
create a second thread for controlling a state of at least one of the target vehicle and the surrounding vehicles,
wherein autonomous driving of the target vehicle is simulated by the simulator using an autonomous driving algorithm.
